(19) United States
(12) Patent Application Publication
(10) Pub. No.: US 2007/0028692 A1
(43) Pub. Date: Feb. 8, 2007

(54) Acoustic wave sensor packaging for reduced hysteresis and creep

(75) Inventor: James Z.T. Liu, Belvidere, IL (US)

Correspondence Address: Attorney, Intellectual Property;Honeywell International Inc., 101 Columbia Rd., P.O. Box 2245, Morristown, NJ, 07962, US

(73) Assignee: Honeywell International Inc.

(21) Appl. No.: 11/199,092

(22) Filed: Aug. 5, 2005

(51) Int. Cl. G01N 29/04

(52) U.S. Cl. 73/584

(57) ABSTRACT

An acoustic wave sensing apparatus includes a substrate having a polished piezoelectric surface. An acoustic wave sensing device (filter, resonator, or delay line) is generally configured from the substrate, such that the polished piezoelectric surface is attachable to a polished metal shaft utilizing an adhesive that reduces hysteresis and creep and improves the performance of the acoustic wave sensing device. The metal shaft is preferably polished in order to reduce the localized stress and contact area associated with the piezoelectric surface of the acoustic wave sensing device and the metal shaft. The adhesive can be implemented as an epoxy adhesive that avoids direct-contact induced frequency instability associated with the contact area.

### TECHNICAL FIELD

Embodiments are generally related to sensing devices and components thereof. Embodiments also related to acoustic wave devices. Embodiments particular relate to surface acoustic wave (SAW) devices. Embodiments are additionally related torque sensors.

### BACKGROUND OF THE INVENTION

Acoustic wave sensors are utilized in a variety of sensing applications, such as, for example, temperature and/or pressure sensing devices and systems. Acoustic wave devices have been in commercial use for over sixty years. Although the telecommunications industry is the largest user of acoustic wave devices, they are also used for in other areas for sensor applications, e.g., (chemical vapor detection). Acoustic wave sensors are so named because they use a mechanical, or acoustic, wave as the sensing mechanism. As the acoustic wave propagates through or on the surface of the material, any changes to the propagation path affect the characteristics of the wave.

Changes in acoustic wave characteristics can be monitored by measuring the frequency, amplitude or phase characteristics of the sensor and can then be correlated to the corresponding physical quantity or chemical quantity that is being measured. Virtually all acoustic wave devices and sensors utilize a piezoelectric substrate to generate the acoustic wave. Three mechanisms can contribute to acoustic wave sensor response, i.e., mass-loading, visco-elastic and acousto-electric effect. The mass-loading of chemicals alters the frequency, amplitude, and phase and Q value of such sensors. Most acoustic wave chemical detection sensors, for example, rely on the mass sensitivity of the sensor in conjunction with a chemically selective coating that absorbs the vapors of interest resulting in an increased mass loading of the acoustic wave sensor.

Examples of acoustic wave sensors include acoustic wave detection devices, which are utilized to detect the presence of substances, such as chemicals, or environmental conditions such as temperature and pressure. An acoustical or acoustic wave (e.g., SAW/BAW) device acting as a sensor can provide a highly sensitive detection mechanism due to the high sensitivity to surface loading and the low noise, which results from their intrinsic high Q factor. Surface acoustic wave devices are typically fabricated using photolithographic techniques with comb-like interdigital transducers placed on a piezoelectric material. Surface acoustic wave devices may have a delay line, a filter, or a resonator configuration. Bulk acoustic wave device are typically fabricated using a vacuum plater, such as those made by CHA, Transat or Saunder. The choice of the electrode materials and the thickness of the electrode are controlled by filament temperature and total heating time. The size and shape of electrodes are defined by proper use of masks.

One area where acoustic wave sensors seem to offer advantages is in the field of torque sensing. In systems incorporating rotating drive shafts, for example, it is often necessary to know the torque and speed of such shafts in order to control the same or other devices associated with the rotatable shafts. Accordingly, it is desirable to sense and measure the torque in an accurate, reliable, and inexpensive manner.

Sensors to measure the torque imposed on rotating shafts, such as but not limited to shafts in automotive vehicles, are utilized in many applications. For example, it might be desirable to measure the torque on rotating shafts in a vehicle's transmission, or in a vehicle's engine (e.g., the crankshaft), or in a vehicle's automatic braking system (ABS) for a variety of purposes known in the art.

One application of this type of torque measurement is in electric power steering systems wherein an electric motor is driven in response to the operation and/or manipulation of a vehicle steering wheel. The system then interprets the amount of torque or rotation applied to the steering wheel and its attached shaft in order to translate the information into an appropriate command for an operating means of the steerable wheels of the vehicle.

One solution to implementing such sensors, particularly SAW quartz pressure and/or torque sensors, involves utilizing all-quartz-packaging (AQP) configurations, which can minimize the thermal expansion mismatch between the quartz sensor substrate and the metal cover. The AQP structure provides sensors with desired performances, including minimum hysteresis, low creep, low aging and improved long-term stability. With their inherent high Q value (i.e., resolution), frequency output (e.g., digital), passive and wireless design, quartz pressure and torque sensors are superior to their counterparts in applications such as truck tire pressure detection and transmission torque measurement.

The AQP structure, however, is quite expensive to manufacture. Additionally, high temperature processes related to the AQP may reduce the sensor performance. Most quartz sensors utilize metal covers. In the metal-quartz configurations, the quartz sensor can be simply placed in contact with appropriate metal structures. Because the external pressure or torque may cause micro-fractures and instable contact in high-stress points of the sensor, the result is poor repeatability and low stability. It is believed that utilizing an adhesive as a medium between the quartz SAW sensor and the metal structures could resolve this problem. The time-dependent visco-elasticity of the adhesive, however, may cause changes in the contact conditions when the sensor is subjected to external pressure or torque, resulting in non-elastic errors, large hysteresis and creep. It is believed that a solution to these problems involves implementation of an improved acoustic wave sensing configuration as depicted herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved sensing device.

It is another aspect of the present invention to provide for an improved acoustic wave sensor.

It is yet another aspect of the present invention to provide for a SAW torque sensor in which creep and hysteresis are reduced.

The aforementioned aspects and other objectives and advantages can now be achieved as described herein. An acoustic wave sensing apparatus and system is disclosed, which includes a substrate having a quartz surface. An acoustic wave sensing resonator is generally configured from the substrate, such that the quartz surface is attachable to a metal shaft utilizing an adhesive that reduces hysteresis and creep and improves the performance of the acoustic wave sensing resonator. The metal shaft is preferably polished in order to reduce the localized stress and contact area associated with the quartz surface of the acoustic wave sensing resonator and the metal shaft. The adhesive can be implemented as an epoxy adhesive that avoids direct-contact induced frequency instability associated with the contact area.

The acoustic wave sensing apparatus and/or system disclosed herein can incorporate the use of a substrate having a surface formed from a piezoelectric material. Such an acoustic wave sensing apparatus and/or system further utilizes an acoustic wave sensing device configured from the substrate, wherein the surface comprising the piezoelectric material surface is attachable to a metal shaft utilizing an adhesive that reduces hysteresis and creep and improves the performance of the acoustic wave sensing device. The surface, which is formed from a piezoelectric material, is preferably polished, thereby providing a polished piezoelectric surface. The metal shaft can also be polished, thereby reducing the contact area associated with the surface of the acoustic wave sensing device and the metal shaft. Polishing of the metal shaft also reduces the localized stress associated with the contact area of the surface of the acoustic wave sensing device.

The adhesive utilized can be implemented as an epoxy adhesive that avoids direct-contact induced frequency instability associated with the contact area. Additionally, the acoustic wave sensing device can be implemented as an All Quartz Packaged (AQP) acoustic wave sensor. Such an AQP acoustic wave sensor can be configured as a quartz SAW resonator sensor. The acoustic wave sensing device can be further configured to incorporate the use of at least one electrode disposed on the substrate.

The piezoelectric material utilized can be implemented from one of the following types of materials: α-quartz, lithium niobate (LiNbO3), and lithium tantalate (LiTaO3) as well as Li2B4O7, AlPO4, GaPO4, langasite (La3Ga5SiO14), ZnO, and/or epitaxially grown (Al, Ga, In) nitrides. Additionally, the acoustic wave sensing device can be implemented as one of the following types of sensors (i.e., or a combination thereof): a flexural plate mode (FMP) sensor, an acoustic plate wave (APW) sensor, a surface transverse wave (STW) sensor, and/or a shear-horizontal acoustic plate mode (SH-APM) sensor.

The acoustic wave sensing device can be further implemented as on one of the following types of sensors: an amplitude plate mode (APM) data sensor, a thickness shear mode (TSM) data sensor, a surface acoustic wave (SAW) sensor, and/or a bulk acoustic wave mode (BAW) sensor. The acoustic wave sensing device can also be implemented as one of the following types of sensors: a torsional mode sensor, a love wave sensor, a leaky surface acoustic wave mode (LSAW) sensor, and a pseudo surface acoustic wave mode (PSAW) sensor. The acoustic wave sensing device can also be configured to include, for example, the following types of electrode materials: Al, Pt, Au, Rh, Ir, Cu, Ti, W, Cr, and Ni; or the following types of alloys: TiN, CoSi2, and WC. Such electrode material can also be configured from metal-nonmetal compounds, such as, for example, NiCr and/or CuAl. The acoustic wave sensing device can also be configured as a resonator, a filter, or a delay line.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a high-level diagram of a torque sensor system, which can be adapted for use in accordance with a preferred embodiment;

FIG. 2 illustrates a perspective view of a wireless torque sensor, which can be adapted for use in accordance with a preferred embodiment;

FIG. 3 illustrates a side view of an electronic control unit, which can be adapted for use in accordance with a preferred embodiment;

FIG. 4 illustrates a high-level diagram of a system for controlling an automotive engine, which can be adapted for use in accordance with a preferred embodiment;

FIG. 5 illustrates a high-level diagram of a system for controlling an automotive transmission, which can be adapted for use in accordance with a preferred embodiment; and

FIG. 6 illustrates a block diagram of a system for wireless transmitting torque detection data to an engine control unit and/or a transmission control unit, which can be adapted for use in accordance with a preferred embodiment;

FIG. 7 illustrates a pictorial diagram of a system that includes SAW torque sensor disposed on a metal shaft, in accordance with a preferred embodiment;

FIG. 8 illustrates a pictorial perspective view of the SAW torque sensor depicted in FIG. 7; and

FIG. 9 illustrates schematic profiles, which illustrate rough surfaces and the contact observable in a micro-mechanism.

### DETAILED DESCRIPTION

The particular values and configurations discussed in these non-limiting examples can be varied and are cited merely to illustrate at least one embodiment and are not intended to limit the scope thereof.

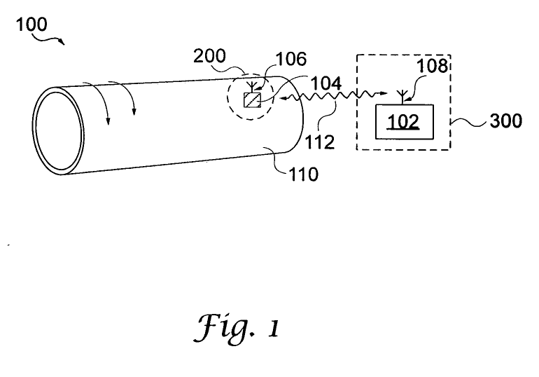

FIG. 1 illustrates a high-level diagram of a torque sensor system 100, which can be adapted for use in accordance with a preferred embodiment. Note that in FIGS. 1-6 herein, like or identical parts or elements are generally indicated by identical reference numerals. System 100 generally includes a rotating member 110 such as a shaft upon which a torque sensing element or sensor 104 can be located for detecting torque associated with rotating member 110. Torque sensor 104 incorporates an antenna 106, which can transmit and receive data to and from an electronics control unit 102 that incorporates an antenna 108. Note that the torque sensor 104 and its associated antenna 106 together can form a wireless torque sensor 200. The antenna 108 can be provided as, for example, a coupler or a capacitive coupling antenna component. The antenna may also be configured as, for example, an inductive coupling or simply a linear antenna.

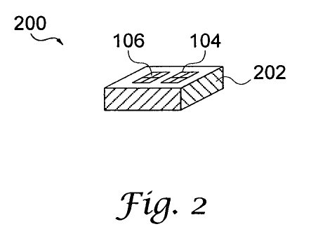

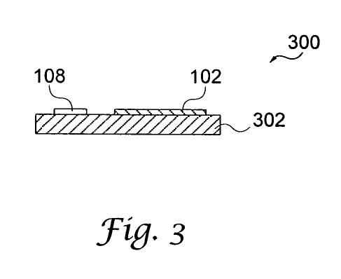

FIG. 2 illustrates a perspective view of a wireless torque sensor 200, which can be implemented in accordance with a preferred embodiment. As indicated in FIG. 2, the wireless torque sensor is generally composed of a torque sensor or sensing element 104 and antenna 106, which are both configured upon the same substrate 202. FIG. 3 illustrates a side view of an electronic control unit 300, which can be implemented in accordance with a preferred embodiment. Note that the electronic control unit 300 generally includes a single substrate 302 upon which both the controlling electronics 102 and the antenna 108 are configured. The torque sensing element 104 can be, for example, a magnetoresistive sensing element. Alternatively, torque sensing element 104 may be configured as an acoustic wave sensing element, such as for example, a surface acoustic wave (SAW) or bulk acoustic wave (BAW) sensing component. If torque sensing element 104 comprises an acoustic wave sensing element, then substrate 202 may be configured as a piezoelectric substrate.

Note that torque sensing element 104 can be provided in the context of an acoustic wave torque sensor. That is, sensing element 104 can be configured as acoustic wave sensing element utilized for the torque sensing operations described herein. Sensing element 104 can therefore be provided as, for example, one or more of the following components: a surface acoustic wave filter, a surface acoustic wave resonator, a surface acoustic wave delay line, a bulk acoustic wave resonator or a combination thereof, depending upon design considerations. Alternatively or in combination with such components, the torque sensing element 104 can be configured as a magneto-elastic toque sensor that measures a magnetic flux. Such a magneto-elastic toque sensor can also be utilized to measure a resonance frequency thereof.

Thus, the torque sensing element 104 is generally attached to the rotating member 110, but the controlling electronics 102 are essentially stationary and located external to the shaft 110 and the wireless torque sensor 200. Signals are therefore transferred between wireless torque sensor 200 and the electronics control unit 300. Note that substrate 302 can be provided, for example, as a printed circuit board (PCB) or a metal layer impregnated with plastic depending upon design considerations.

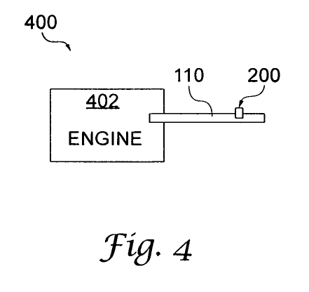

FIG. 4 illustrates a high-level diagram of a system 400 for controlling an automotive engine 402, which can be implemented in accordance with one embodiment. Note that system 400 can be implemented in accordance with the configurations depicted in FIGS. 1-3 herein. In system 400, the rotating member of shaft 110 can be connected to or utilized in association with engine 402. The wireless torque sensor 200 is mounted to the shaft 110 for detecting torque associated with shaft 110.

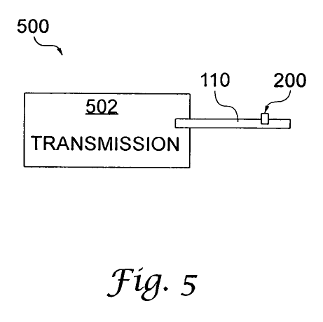

FIG. 5 illustrates a high-level diagram of a system 500 for controlling an automotive transmission, which can be implemented in accordance with another embodiment. System 500 can also be implemented in accordance with the configurations depicted in FIGS. 1-3. In system 500, an automotive transmission 502 is connected to rotating member or shaft 110. Torque sensor 200 is again mounted to shaft 110 and transmits torque sensing data wireless to, for example, the electronics control unit 300 described earlier.

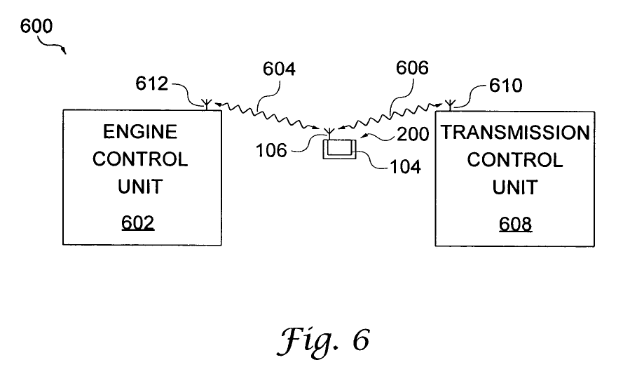

FIG. 6 illustrates a block diagram of a system 600 for wirelessly transmitting torque detection data to an engine control unit 602 and/or a transmission control unit 608, in accordance with a preferred embodiment. Again, it is important to note in FIGS. 1-6, identical or similar parts or elements are generally indicated by identical reference numerals. Engine control unit 602 can be utilized to control operations associated with engine 402 depicted in FIG. 4. Engine control unit 602 incorporates an antenna 612, which transmits data wirelessly to and from wireless torque sensor 200, which can be located on shaft 110, as indicated earlier. Similarly, transmission control unit 608 incorporates the use of an antenna 610. Transmission control unit 608 generally controls operations associated with transmission 502 depicted in FIG. 5. Torque detection data can be transmitted wirelessly from the wireless torque sensor 200 to antenna 610 as indicated by arrow 610. The wireless transmission of data to torque sensor 200 and from engine control unit 602 is indicated in FIG. 6 by arrow 604.

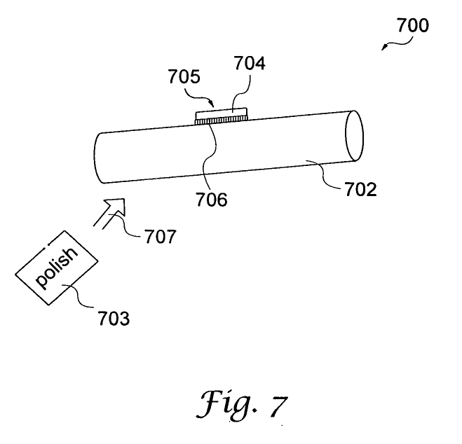

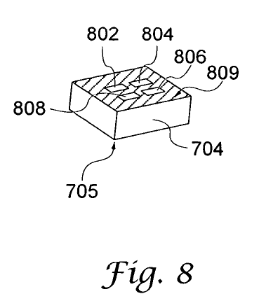

FIG. 7 illustrates a pictorial diagram of a system 700 that includes a SAW torque sensor 705 disposed on a metal shaft 702, in accordance with a preferred embodiment. The SAW torque sensor 705 is formed from a substrate 704 that is similar to the substrates 202, 302 respectively depicted in FIGS. 2-3, but which may differ in structure and the use of substrate materials, depending upon design considerations. FIG. 8 illustrates a pictorial perspective view of the SAW torque sensor 705 depicted in FIG. 7. Note that in FIGS. 7-8 identical or similar parts or elements are generally indicated by identical reference numerals. In general, system 700 can be modified for use in accordance with the features depicted in FIGS. 1-6 herein. For example, the metal shaft 702 depicted in FIG. 7 is analogous to the rotating member 110 depicted in FIG. 1. Similarly, the SAW torque sensor 705 depicted in FIGS. 7-8 can be implemented as torque sensor 200 depicted earlier, although with few or more resonator elements 106, 104. The SAW torque sensor 705 depicted in FIGS. 7-8 generally functions as a metal-quartz torque sensor for sensing torque associated with metal shaft 702.

System 700 generally includes the acoustic wave sensing apparatus or SAW sensor 705 that is composed of a quartz substrate 702 having a quartz surface 809, which is shown in greater detail in FIG. 8. The acoustic wave sensing apparatus or SAW sensor 705 generally includes one or more SAW resonators 802, 804, 806, 808 configured on the quartz surface 809. Note that the SAW resonators 802, 804, 806, 808 depicted in FIG. 8 are essentially analogous to the resonator components 105, 106, 108 depicted in FIGS. 2-3. The acoustic wave sensing apparatus or SAW sensor 705 can thus function as an acoustic wave sensing resonator having quartz surface 809 thereof. The quartz surface 809 of the acoustic wave sensing resonator can be attached to the metal shaft 702 utilizing an adhesive 706, which can reduce hysteresis and creep and improves the performance of the acoustic wave sensing resonator or sensor 705.

The metal shaft 702 can be preferably polished as indicated graphically by block 703 and arrow 707 in FIG. 7, thereby reducing the contact area associated with the quartz surface 809 of the acoustic wave sensing resonator device 705 and the metal shaft 702. Polishing of the metal shaft 702, as indicated by block 703 and arrow 707 also reduces the localized stress associated with the contact area of the quartz surface 809 of the acoustic wave sensing resonator device or SAW sensor 705.

The adhesive 706 can be configured as an epoxy adhesive that avoids direct-contact induced frequency instability associated with the contact area of the quartz surface 809 and the metal shaft 702. The configuration in depicted in FIGS. 7-8 generally results in reducing the creep characteristics of a metal-quartz torque sensor, such as sensor 705. The sensing quartz SAW resonator device 705 is in contact with metal shaft 702 by the epoxy adhesive 706 to avoid direct-contact induced frequency instability. The creep of the sensor 705 mainly attributes to the existence of epoxy, owing to its visco-elastic feature.

Experimental results can demonstrate that the decrease of the surface roughness or with the increase of the pre-load, as well as the elasticity of the epoxy utilized for adhesive 706, along with the creep of the sensor 705, can be reduced. A polishing methodology can be utilized, based on such experiments to reduce creep and improve the performance of the sensor 705.

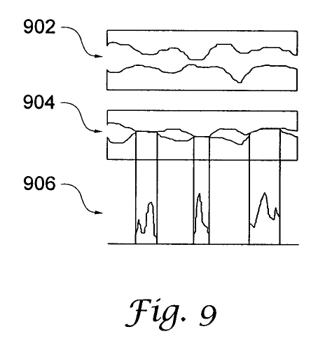

FIG. 9 illustrates schematic profiles 902, 904, and 906, which illustrate rough surfaces and the contact observable in a micro-mechanism. Schematic 902 depicts a surface before contact, while schematic profile 904 illustrates surfaces after contact. Additionally, schematic profile 906 indicates surfaces after contact. The configuration depicted in FIG. 9 is presented to explain the metal-quartz surface (rough). When the surface is rough, less contact is available and localized stress increases. In generally, hysteresis and creep of a metal-quartz sensor can be caused by the visco-elasticity of the adhesive and the stress relation of the metal-quartz contact. Hysteresis and creep are related to surface roughness, pre-load, and epoxy adhesives. Smoother surfaces are thus helpful for decreasing hysteresis and creep as a result of larger contact area and less epoxy. Although hysteresis and creep can benefit from larger pre-loads, there is an optimal range for the pre-load because too large a pre-load results in small measurement ranges. Thus, based on FIG. 9 it can be appreciated that a pre-load can be adapted for use with the configuration depicted, for example, in FIGS. 7-8, such that the pre-load, which related to the surface roughness of the metal shaft 702 and the piezoelectric substrate surface 809, can be utilized to obtain a desired hysteresis an/or creep value.

Based on the foregoing, it can be appreciated that the acoustic wave sensing apparatus 705 can incorporate the use of a substrate 704 having a surface 809 formed from a piezoelectric material. Such an acoustic wave sensing device 705 configured from the substrate 704, such that the surface 809 constitutes a piezoelectric material surface that is attachable to the metal shaft 702 utilizing the adhesive 706, which reduces hysteresis and creep and improves the performance of the acoustic wave sensing device 705. The surface 809, which is formed from the piezoelectric material, is preferably polished, thereby providing a polished piezoelectric surface. The metal shaft 702 can also be polished, thereby reducing the contact area associated with the surface 809 of the acoustic wave sensing device 705 and the metal shaft 702. Polishing of the metal shaft 702 also reduces the localized stress associated with the contact area of the surface 809 of the acoustic wave sensing device.

The adhesive 706 utilized can be implemented as an epoxy adhesive that avoids direct-contact induced frequency instability associated with the contact area. Additionally, the acoustic wave sensing device 705 can be implemented as an All Quartz Packaged (AQP) acoustic wave sensor. Such an AQP acoustic wave sensor 705 can be configured as a quartz SAW resonator sensor. The acoustic wave sensing device 705 can be further configured to incorporate the use of one or more electrodes, such as, for example, electrodes 802, 804 806, 808 disposed on the substrate 704.

The piezoelectric material utilized to implement substrate 704 can be, for example, materials such as x-quartz, lithium niobate (LiNbO3), and lithium tantalate (LiTaO3) as well as Li2B4O7, AlPO4, GaPO4, langasite (La3Ga5SiO14), ZnO, and/or epitaxially grown (Al, Ga, In) nitrides. Additionally, the acoustic wave sensing device 705 can be implemented as an acoustic sensor, such as, for example, a flexural plate mode (FMP) sensor, an acoustic plate wave (APW) sensor, a surface transverse wave (STW) sensor, and/or a shear-horizontal acoustic plate mode (SH-APM) sensor.

The acoustic wave sensing device 705 can also be implemented as, for example, an amplitude plate mode (APM) data sensor, a thickness shear mode (TSM) data sensor, a surface acoustic wave (SAW) sensor, and/or a bulk acoustic wave mode (BAW) sensor. The acoustic wave sensing device 705 can also be implemented as a torsional mode sensor, a love wave sensor, a leaky surface acoustic wave mode (LSAW) sensor, and/or a pseudo surface acoustic wave mode (PSAW) sensor. The acoustic wave sensing device 705 can also be configured, for example, such that electrodes 802, 804, 806, and 808 are formed from electrode materials such as Al, Pt, Au, Rh, Ir, Cu, Ti, W, Cr, and/or Ni; or the following types of alloys: TiN, CoSi2, and WC. Such electrode material can also be configured from metal-nonmetal compounds, such as, for example, NiCr and/or CuAl. The acoustic wave sensing device 705 can also be configured as a resonator, a filter, or a delay line.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An acoustic wave sensing apparatus, comprising:
a substrate having a surface formed from a piezoelectric material; and
an acoustic wave sensing device configured from said substrate, wherein said surface comprising said piezoelectric material surface is attachable to a metal shaft utilizing an adhesive that reduces hysteresis and creep and improves the performance of said acoustic wave sensing device.

2. The apparatus of claim 1 further comprising a preload indicative of a surface roughness of said metal shaft and said surface, wherein said preload is utilized to obtain a desired hysteresis value and a desired creep value thereof.

3. The apparatus of claim 1 wherein said surface is polished, thereby comprising a polished piezoelectric surface.

4. The apparatus of claim 1 wherein said metal shaft is polished, thereby reducing a contact area associated with said surface of said acoustic wave sensing device and said metal shaft.

5. The apparatus of claim 4 wherein said metal shaft is polished, thereby reducing a localized stress associated with said contact area of said surface of said acoustic wave sensing device.

6. The apparatus of claim 4 wherein said adhesive comprises an epoxy adhesive that avoids direct-contact induced frequency instability associated with said contact area.

7. The apparatus of claim 1 wherein said acoustic wave sensing device comprises an All Quartz Packaged (AQP) acoustic wave sensor.

8. The apparatus of claim 7 wherein said AQP acoustic wave sensor comprises a quartz SAW resonator sensor.

9. The apparatus of claim 1 wherein said acoustic wave sensing device comprises at least one electrode disposed on said substrate.

10. An acoustic wave sensing system, comprising:
a substrate having a surface formed from a piezoelectric material, wherein said surface is polished, thereby comprising a polished piezoelectric surface;
a metal shaft; and
an acoustic wave sensing device configured from said substrate, wherein said surface is attachable to said metal shaft utilizing an adhesive that reduces hysteresis and creep and improves the performance of said acoustic wave sensing device, wherein said metal shaft is polished, thereby reducing a contact area associated with said surface of said acoustic wave sensing device and said metal shaft while additionally reducing a localized stress associated with said contact area of said surface of said acoustic wave sensing device.

11. The system of claim 10 wherein said piezoelectric material is selected from a group of materials comprising at least one of the following materials: α-quartz, lithium niobate (LiNbO3), and lithium tantalate (LiTaO3) as well as Li2B4O7, AlPO4, GaPO4, langasite (La3Ga5SiO14), ZnO, and epitaxially grown (Al, Ga, In) nitrides.

12. The system of claim 10 wherein said acoustic wave sensing device comprises at least one of the following types of sensors: a flexural plate mode (FMP) sensor, an acoustic plate wave (APW) sensor, a surface transverse wave (STW) sensor, and a shear-horizontal acoustic plate mode (SH-APM) sensor.

13. The system of claim 10 wherein said acoustic wave sensing device further comprises at least one of the following types of sensors: an amplitude plate mode (APM) data sensor, a thickness shear mode (TSM) data sensor, a surface acoustic wave (SAW) sensor, and a bulk acoustic wave mode (BAW) sensor.

14. The system of claim 10 wherein said acoustic wave sensing device further comprises at least one of the following types of sensors: a torsional mode sensor, a love wave sensor, a leaky surface acoustic wave mode (LSAW) sensor, and a pseudo surface acoustic wave mode (PSAW) sensor.

15. The system of claim 10 wherein said acoustic wave sensing device comprises electrode materials chosen from among a group comprising at least one of the following types of metals: Al, Pt, Au, Rh, Ir, Cu, Ti, W, Cr, and Ni.

16. The system of claim 10 wherein said acoustic wave sensing device comprises electrode materials chosen from among a group of materials comprising at least one of the following types of alloys: TiN, CoSi2, and WC.

17. The system of claim 10 wherein said acoustic wave sensing device comprises an electrode material chosen from among a group comprising at least one of the following types of metal-nonmetal compounds: NiCr and CuAl.

18. An acoustic wave sensor system, comprising:
a substrate having a surface formed from a piezoelectric material, wherein said surface is polished, thereby comprising a polished piezoelectric surface, wherein said piezoelectric material is selected from a group of materials comprising at least one of the following materials: α-quartz, lithium niobate (LiNbO3), and lithium tantalate (LiTaO3) as well as Li2B4O7, AlPO4, GaPO4, langasite (La3Ga5SiO14), ZnO, and epitaxially grown (Al, Ga, In) nitrides; and
an acoustic wave sensing device configured from said substrate, wherein said surface is attachable to a metal shaft utilizing an adhesive that reduces hysteresis and creep and improves the performance of said acoustic wave sensing device, wherein said metal shaft is polished, thereby reducing a contact area associated with said surface of said acoustic wave sensing device and said metal shaft while additionally reducing a localized stress associated with said contact area of said surface of said acoustic wave sensing device.

19. The system of claim 18 wherein said acoustic wave sensing device comprises a resonator.

20. The system of claim 18 wherein said acoustic wave sensing device comprises a filter.

21. The system of claim 18 wherein said acoustic wave sensing device comprises a delay line.
